(19) United States
(12) Patent Application Publication
(10) Pub. No.: US 2019/0184475 A1
(43) Pub. Date: Jun. 20, 2019

(54) Single-Edged Milling Tool

(71) Applicant: DATRON AG, Iviuhltal (DE)

(72) Inventor: Frank Dolze, Darmstadt (DE)

(73) Assignees: DATRON AG, Mühltal (DE); DATRON AG, Mühltal (DE)

(21) Appl. No.: 16/328,897

(22) PCT Filed: Jun. 22, 2017
(86) PCT No.: PCT/EP2017/065417

§ 371 Date: Feb. 27, 2019

(30) Foreign Application Priority Data
Aug. 31, 2016 (DE) 10 2016 116 279.5

(51) Int. Cl. B23C 5/10

(52) U.S. Cl. CPC B23C 5/1081; B23C 2210/201; B23C 2210/086; B23C 2210/082

(57) ABSTRACT

A single-edged milling tool has a shaft section and a machining section. A face cutting edge is formed on a distal end of the machining section. The face cutting edge extends radially from an outside end at an outer peripheral edge to an inside end close to the axis of rotation. The face cutting edge has an outer peripheral planar portion at a constant planar distance to a reference plane extending perpendicular to the axis of rotation. An oblique portion connects the planar portion to the inside end. The oblique portion of the face cutting edge is closer to the reference plane than the planar portion. The distance of the face cutting edge from the reference plane in the oblique portion diminishes continuously starting out from the planar portion to the inside end of the face cutting edge.

### TECHNICAL FIELD

The invention relates to a single-edged milling tool with a shaft section and a machining section, wherein on an end of the machining section facing away from the shaft section there is formed a face cutting edge, which extends in a radial direction from an outside end at an outer peripheral edge as far as an inside end arranged at a distance from the outer peripheral edge and close to the axis of rotation.

### BACKGROUND

Cutting tools are known in a variety of embodiments and are used, for example, as drills or milling cutters. In the machining section the cutting tool can have one or more cutting edges, which can separate material from a workpiece to be machined on rotation of the cutting tool. The separated chips are normally taken away from the workpiece by a flute or by several flutes, wherein the one flute or several flutes preferably extend helically in an axial direction along the axis of rotation from the at least one cutting edge in the direction of the shaft section.

Cutting tools are known that have one or more interchangeable cutting blades, each with a cutting edge. Cutting tools manufactured in one piece are also known, in which a cutting edge or several cutting edges are formed in the machining section. The interchangeable cutting blades or the cutting edges formed in one piece in the machining section of the cutting tool can be directed radially outwards and on a rotation of the cutting tool can machine a shell surface predefined by the progression of the cutting edges taking place in an axial direction along the outer peripheral edge. The cutting blades or cutting edges can also be arranged on an end face of the cutting tool and on plunging of the cutting tool into the workpiece to be machined can separate material at the end face of the cutting tool and convey separated chips away from the workpiece. A single-edged milling tool is often manufactured in one piece and has a single cutting edge, which extends over an area of the end face. The cutting edge often also extends over a portion of the machining section adjoining the end face and extends along an outer peripheral edge in an axial direction. The portion extending on the end face is termed the face cutting edge below and a portion extending, if applicable, in an axial direction along an outer peripheral edge is termed a sheath cutting edge.

Single-edged milling tools manufactured in one piece normally have a diameter of up to 20 mm. Larger milling tools with a larger diameter are designed in several parts in many cases and can have several cutting edges or interchangeable cutting blades. It is likewise possible that the machining section is formed in one piece and can be separated from the shaft section and exchanged if necessary.

A single-edged milling tool of the type named at the beginning can advantageously be used as a milling tool. Using the face cutting edge formed on the end face a surface of the workpiece facing the end face can also be machined. Single-edged milling tools are known with a flat face cutting edge, which is oriented perpendicular to the axis of rotation and extends from an outer peripheral edge in the direction of the axis of rotation and normally beyond the axis of rotation of the single-edged milling tool. With such a completely flat face cutting edge or face cutting edge oriented perpendicular to the axis of rotation, qualitatively high-grade surface machining of the workpiece can be carried out and a virtually completely flat surface achieved in an area of the workpiece machined with this. However, such surface machining permits only comparatively low cutting values and a low feed rate of the single-edged milling tool in an axial direction on plunging into the workpiece. In milling movement in a radial direction to the single-edged milling tool, the predominant part of the face cutting edge rubs non-functionally on the surface to be machined, which has a negative effect on the cutting values and the service life. Single-edged milling tools of this kind are normally only used in practice if qualitatively high-grade surface machining of the workpiece is required and the higher machining outlay appears economically justified.

Single-edged milling tools are also known with a face cutting edge with a progression that is at an angle to a perpendicular onto the axis of rotation, so that the face cutting edge penetrates deeper into the workpiece to be machined as the radial distance from the axis of rotation increases outwardly. The rotating face cutting edge forms a conical sheath surface, for example, which permits high cutting values and greater feed rates in machining of the workpiece and thereby represents the more economical milling tool for the machining of the workpiece. However, the surface of the workpiece machined with the obliquely extending face cutting edge is not completely flat, but on the contrary is formed by a large number of groove-shaped depressions, which are produced by the rotating face cutting edge extending obliquely at an angle to the flat surface.

It is therefore known in practice to machine a workpiece initially with a single-edged milling tool with an obliquely extending face cutting edge and subsequently to finish, with another milling tool or cutting tool or using other methods, only those surfaces of the workpiece that must have a high surface quality and in particular as flat a surface as possible.

### SUMMARY

It is regarded as an object of the present invention to improve a single-edged milling tool of the type named at the beginning in such a way that in the most economical machining possible of a workpiece, the highest possible finish quality of a machined surface of the workpiece is made possible at the same time.

This object is achieved in that the face cutting edge has at its outside end facing the outer peripheral edge a planar portion, in which the face cutting edge has a constant planar distance to a reference plane extending perpendicular to the axis of rotation in the shaft section, and an oblique portion attached to the planar portion and extending as far as the inside end, in which oblique portion the face cutting edge has a smaller distance than the planar distance to the reference plane. The planar portion of the rotating face cutting edge passes over a circular ring on the surface of the workpiece, the outer circle of which is formed by the end of the planar portion lying radially outside and the inner circle of which is formed by the end of the planar portion lying radially inside. In this planar portion the face cutting edge extends in one plane perpendicular to the axis of rotation and forms a completely flat cutting face. The face cutting edge can extend in a straight line in this case and extend radially outwards perpendicular to the axis of rotation. In a plane aligned perpendicular to axis of rotation, however, the face cutting edge can also have a curved progression, in order to extend along a shell surface of a flute, for example. The curved progression of the face cutting edge is clearly recognizable in an end face view of the single-edged milling tool, while in a side view the constant planar distance of the face cutting edge in the planar portion becomes clear. In a side view it is also recognizable that opposite to the direction of rotation a free surface connects to the face cutting edge, wherein the normally flat free surface has a clearance angle of a few degrees to the plane in which the planar portion of the face cutting edge extends.

If the single-edged milling tool is moved parallel to the machining surface of the workpiece at a feed rate that is measured so that the predefined lateral feed during one revolution of the single-edged milling tool is sufficiently smaller than a ring width of the circular ring formed by the rotating planar portion, the surface of the workpiece is finished exclusively by the planar portion of the face cutting edge and a surface of the workpiece that is virtually completely flat in practice is produced.

It has been shown that significantly higher cutting values and feed rates can be achieved by the oblique portion of the face cutting edge extending diagonally, which section is connected to the planar portion, than with a completely flat face cutting edge, as the advantageous properties of an obliquely extending face cutting edge are very largely retained by the oblique portion both on plunging of the single-edged milling tool into the workpiece and in a movement of the single-edged milling tool taking place parallel to the surface to be machined. The face cutting edge may be configured with a flat planar portion and an oblique portion extending diagonally towards the axis of rotation in the direction of the shaft section. This allows both fast and economical machining of a workpiece and provides a high surface quality of a machined surface section of a workpiece.

It is generally possible and advantageous for countless applications of the single-edged milling tool that the single-edged milling tool also has a sheath cutting edge extending along the outer peripheral edge in an axial direction in the machining section. The sheath cutting edge extends in an axial direction as far as the end face of the single-edged milling tool and connects to the face cutting edge, so that the sheath cutting edge merges in the area of the end face into this. Extending expediently along the sheath cutting edge and the face cutting edge is a flute, in which the separated chips are led away from the face cutting edge and if applicable from the sheath cutting edge and can be carried away from the machined workpiece.

Starting out from the outer peripheral edge, the face cutting edge can extend in a radial direction even beyond the axis of rotation, which is regarded as advantageous for many application areas. It has been shown beneficial in practice if a face cutting edge extends beyond the axis of rotation to a side opposite the outer end of the face cutting edge up to a radial distance from the axis of rotation of roughly 1% to 20%, preferably 2% to 10% of the radius of the single-edged milling tool. In this way it can be ensured that the face cutting edge completely passes over the area of the workpiece facing the end face in a rotation of the milling tool and can separate material over the entire surface without a central cone remaining on the workpiece in extension of the axis of rotation, for example. On the single-edged milling tool the face cutting edge can have an increasingly smaller distance to the reference plane in the area of the oblique portion extending on the other side of the axis of rotation, but if necessary also a constant distance or possibly a distance that increases again to the reference plane, which must, however, be smaller in any case than the planar distance of the planar portion to the reference plane.

According to an advantageous configuration of the inventive idea, it is provided that the planar portion of the face cutting edge has a length between 2% and 60%, preferably a length between 3% and 20% of the length of the face cutting edge. It has been shown that with a planar portion of the face cutting edge that has such a length, the high feed rates normal for face cutting edges that extend completely obliquely can be retained and at the same time qualitatively high-grade surface machining can be achieved by the planar portion of the face cutting edge. It appears practical to adapt the length of the planar portion of the face cutting edge with regard to a desired feed rate in the machining of a workpiece in such a way that the ring width of the virtually annular surface passed over by the planar portion, which ring width is produced during a complete revolution and during a lateral displacement of the face cutting edge taking place with the feed rate, is larger than the lateral feed path covered with the lateral feed rate during a complete revolution of the single-edged milling tool. It can be ensured in this way that when machining a surface of a workpiece, the planar portion of the face cutting edge is led over the entire surface to be machined and a substantially completely flat surface of the workpiece can be produced thereby.

In a superposition of a lateral feed with the rotation of the single-edged milling tool, the planar portion of the face cutting edge passes over a circular ring, which is displaced continuously in the feed direction and does not completely overlap after a complete revolution or is open, and the ends of which are displaced relative to one another in the feed direction. The length of the planar portion of the face cutting edge should accordingly be sufficiently great to be able to pass completely over the surface to be machined at the desired feed rate without a gap occurring between successive revolutions of the planar portion. The length of the planar portion can also be only 1% or more than 40%, namely possibly 50% or 60% of the length of the face cutting edge, depending on the length of the face cutting edge and the targeted feed rate during an operation.

It is provided that the distance of the face cutting edge from the reference plane decreases continuously in the oblique portion starting out from the planar portion as far as the inside end of the face cutting edge. A stepless or continuous progression of the face cutting edge has advantageous properties with respect to the manufacturing outlay of the single-edged milling tool and for its service life. Furthermore, it is guaranteed in particular by a continuous transition from the planar portion to the oblique portion and as far as the inside end of the face cutting edge that no sharp chip edges can arise in surface machining of a workpiece.

In regard to the most economical machining possible of the workpiece and at the same time a high service life of the single-edged milling tool, it is provided that a reference diagonal extending in a straight line through the outside end and the inside end of the face cutting edge has an angle of between 2° and 30°, preferably between 3° and 10° relative to a perpendicular to the axis of rotation. The distance of the face cutting edge to the reference plane is at its greatest in the planar portion and diminishes increasingly as the distance to the axis of rotation decreases, but only by an amount that is much smaller than the distance of the outer peripheral edge of the single-edged milling tool from the axis of rotation. The face cutting edge can be designed mechanically stably due to this and be supported as far as the outer peripheral edge by material of the single-edged milling tool located behind it in the direction of rotation, due to which long service lives are promoted.

According to an advantageous configuration of the inventive idea, it is provided that the shell surface formed by the oblique portion during a rotation about the axis of rotation is conical. It is preferably provided that the surface line of the conical shell surface has an inclination of between 2° and 30°, preferably between 3° and 10° relative to a perpendicular to the axis of rotation. A configuration of the face cutting edge of this kind can be produced particularly cost-effectively.

It is further provided that the face cutting edge has a chamfer on the outer peripheral edge. Such a chamfer, which normally only extends over a few micrometers, is used to avoid tapering ends of a cutting edge that break off during operation, then producing an uneven cross section on account of the resulting irregular broken-off edges.

According to an advantageous configuration of the inventive idea, it is provided that the course of the face cutting edge follows a circumferential line of a flute extending preferably helically in an axial direction. The face cutting edge extends expediently along a shell surface of the flute, so that the face cutting edge has a progression that is curved in space. The configuration and shaping of the flute can be adapted to the materials used for the single-edged milling tool and to the materials of the workpiece that are to be machined by the single-edged milling tool. The regular aim is that the chips occurring during machining of the workpiece are rapidly removed by the flute and that any structural weakness of the single-edged milling tool due to the recess forming the flute is as slight as possible. It has proved advantageous that the face cutting edge extends directly adjacent to the flute and has no lateral or axial offset to the flute, for example.

### BRIEF DESCRIPTION OF THE DRAWINGS

Various exemplary embodiments of single-edged milling tools are described by way of example below and depicted in the drawings.

FIG. 1 is a side view of a schematically depicted single-edged milling tool.

FIG. 2 is an enlarged depiction of section II in FIG. 1.

FIG. 3 is a side view of a single-edged milling tool.

FIG. 4 is another side view of the single-edged milling tool shown in FIG. 3 from a direction rotated by 90°.

FIG. 5 is a plan view of an end face of the single-edged milling tool depicted in FIGS. 3 and 4.

### DETAILED DESCRIPTION

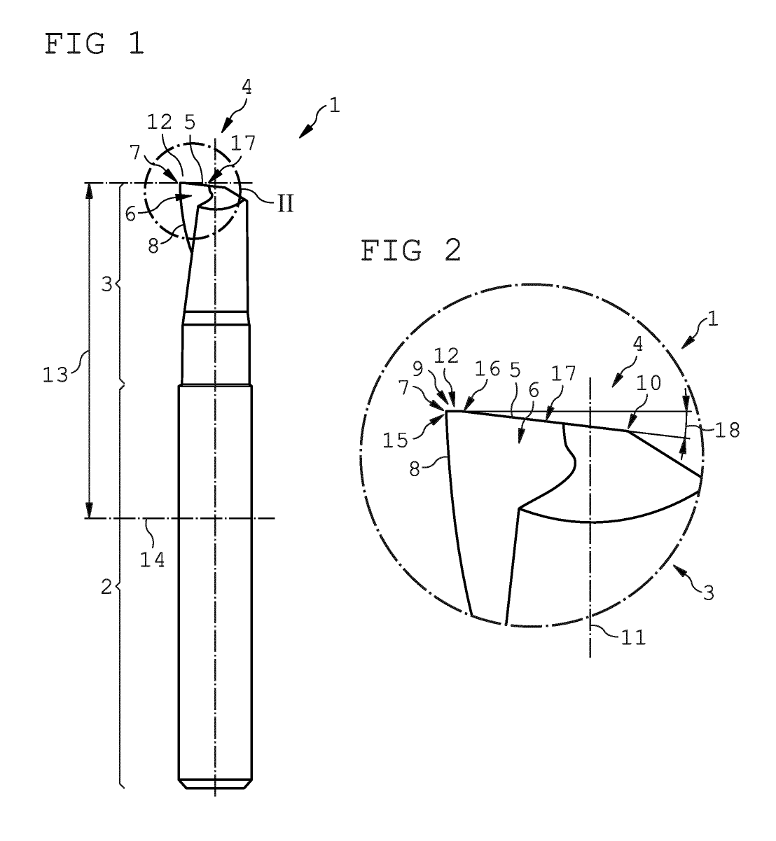

The two single-edged milling tools 1 illustrated by way of example in FIGS. 1 and 2 as well as 3 to 5 have a substantially cylindrical shaft section 2, which can be inserted into a milling spindle, not shown, of a milling machine and serves to fix the single-edged milling tool 1 in the milling machine. Connecting to the shaft section 2 is a machining section 3, formed on the end-side end 4 of which, facing away from the shaft section 2, is a face cutting edge 5.

A flute 6 extends in an axial direction over the machining section 3 and joins the end 4 of the machining section 3 on the end face. Along the flute 6 there is formed in an axial direction on an outer peripheral edge 7 of the single-edged milling tool 1 a sheath cutting edge 8 extending in an axial direction. The sheath cutting edge 8 merges into the face cutting edge 5 at the outer peripheral edge 7 on the end face. The face cutting edge 5 extends from an outside end 9 on the outer peripheral edge 7 as far as an inside end 10 close to the axis of rotation, which is arranged at a distance from the outer peripheral edge 7 and is located in the vicinity of an axis of rotation 11 of the single-edged milling tool 1, about which axis the single-edged milling tool 1 rotates during the operation. The face cutting edge 5 extends through the axis of rotation 11 here.

The face cutting edge 5 has a planar portion 12 at its outside end 9 facing the outer peripheral edge 7. Inside the planar portion 12 the face cutting edge 5 has a constant planar distance 13 to a reference plane 14 extending perpendicular to the axis of rotation 11 in the shaft section 2. The face cutting edge 5 accordingly extends in the planar portion 12 in a plane that extends perpendicular to the axis of rotation 11. In a rotation of the single-edged milling tool 1 about the axis of rotation 11, the planar portion 12 passes in a plane arranged perpendicular to the axis of rotation 11 over an annular surface, the outer and inner radius of which is formed by an outer end 15 of the planar portion 12 facing the outside end 9 and by an inner end 16 of the planar portion 12 facing the inside end 10.

Connecting to the planar portion 12 is an oblique portion 17 of the face cutting edge 5 that extends as far as the inside end 10. In the oblique portion 17 the face cutting edge 5 has a smaller distance to the reference plane 14 than the planar portion 12 with its planar distance 13.

In the single-edged milling tool 1 schematically depicted in the exemplary embodiment according to FIGS. 1 and 2, the oblique portion 17 extends beyond the axis of rotation 11 as far as the inside end 10 of the face cutting edge 5 lying opposite the outer peripheral edge 7 on the other side of the axis of rotation 11. The oblique portion 17 in this implementation variant extends in a straight line in the side view depicted in FIGS. 1 and 2, at an angle 18 of about 6° between the oblique portion 17 extending in a straight line and a perpendicular to the axis of rotation 11 that extends through the planar portion 12 of the face cutting edge 5.

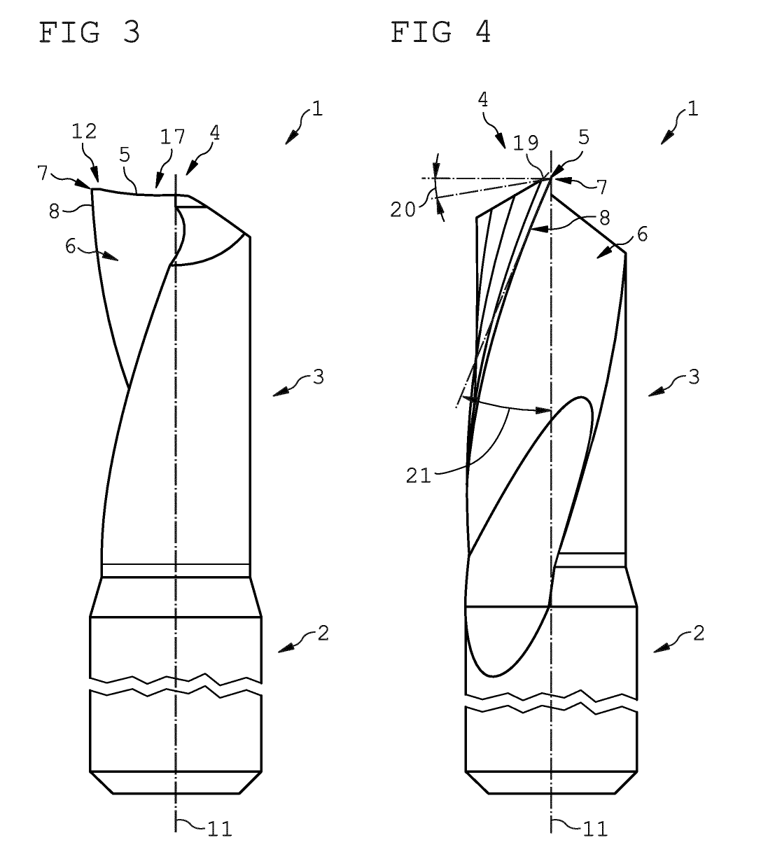

In the exemplary embodiment of the inventive single-edged milling tool 1 depicted in FIGS. 3 to 5, the face cutting edge 5 has a curved progression that is clearly recognizable in the side view shown in FIG. 3, which progression follows a circumferential line or the shell surface of the flute 6. Connecting to this curved progression is an end section extending substantially in a straight line, which leads through the axis of rotation 11. In this exemplary embodiment also, the course of the oblique portion 17 of the face cutting edge 5 and the respective distance of the face cutting edge 5 in the oblique portion 17 relative to the reference plane 14 in the shaft section is predefined so that in a rotation of the single-edged milling tool 1 about the axis of rotation 11, a conical shell surface is formed by the oblique portion 17. The surface line of the conical shell surface has an inclination of roughly 5° relative to a perpendicular to the axis of rotation 11.

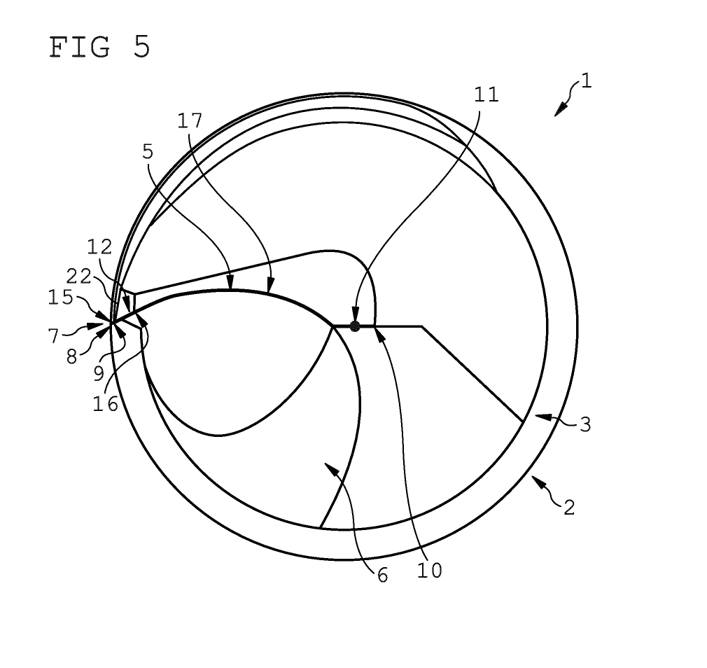

The planar portion 12 of the face cutting edge 5 in the exemplary embodiment according to FIGS. 3 to 5 also has a curved progression adapted to the shaping of the flute 6, wherein the planar distance 13 of the face cutting edge 5 relative to the reference plane 14 is constant and the curvature of the face cutting edge 5 adapted to the shaping of the flute 6 in the planar portion 12 happens exclusively in a plane arranged perpendicular to the axis of rotation 11, which plane coincides with the image plane in FIG. 5. Connecting to the face cutting edge 5 opposite to the direction of rotation is a free surface 19 that is clearly recognizable in FIG. 4 and is formed flat and has an angle 20 of several degrees relative to the plane oriented perpendicular to the axis of rotation 11. The flute 6 joins the face cutting edge 5 with a rake angle 21.

A chamfer 22 is arranged on the outer peripheral edge 7, in order to avoid an uncontrolled breaking-off of the face cutting edge 5 at the outer peripheral edge 7 during operation.

1.-8. (canceled)

9. A single-edged milling tool, comprising:
a shaft section;
a machining section; and
a face cutting edge formed on a distal end of the machining section facing away from the shaft section, the face cutting edge extending radially from an outside end at an outer peripheral edge to an inside end close to an axis of rotation at a distance from the outer peripheral edge,
wherein the face cutting edge has
a planar portion at its outside end facing the outer peripheral edge in which the face cutting edge has a constant planar distance to a reference plane extending perpendicular to the axis of rotation in the shaft section, and
an oblique portion connecting to the planar portion and extending to the inside end, in which the face cutting edge has a smaller distance to the reference plane than the planar distance.

10. The single-edged milling tool according to claim 9, wherein the planar portion of the face cutting edge has a length between 2% and 60% of the length of the face cutting edge.

11. The single-edged milling tool according to claim 9, wherein the planar portion of the face cutting edge has a length between 3% and 20% of the length of the face cutting edge.

12. The single-edged milling tool according to claim 9, wherein the distance of the face cutting edge from the reference plane in the oblique portion diminishes continuously starting out from the planar portion to the inside end of the face cutting edge.

13. The single-edged milling tool according to claim 12, wherein a reference diagonal extending in a straight line through the outside end and the inside end of the face cutting edge has an angle of between 2° and 30° relative to a perpendicular to the axis of rotation.

14. The single-edged milling tool according to claim 12, wherein a reference diagonal extending in a straight line through the outside end and the inside end of the face cutting edge has an angle of between 3° and 10° relative to a perpendicular to the axis of rotation.

15. The single-edged milling tool according to claim 12, wherein a shell surface formed by the oblique portion during rotation about the axis of rotation is conical.

16. The single-edged milling tool according to claim 15, wherein a surface line of the conical shell surface has an inclination between 2° and 30° relative to a perpendicular to the axis of rotation.

17. The single-edged milling tool according to claim 15, wherein a surface line of the conical shell surface has an inclination between 3° and 10° relative to a perpendicular to the axis of rotation.

18. The single-edged milling tool according to claim 9, wherein the face cutting edge has a chamfer on the outer peripheral edge.

19. The single-edged milling tool according to claim 9, wherein the face cutting edge follows a circumferential line of a flute extending in an axial direction.
